(19) United States
(12) Patent Application Publication
(10) Pub. No.: US 2025/0317872 A1
(43) Pub. Date: Oct. 9, 2025

(54) METHOD, DEVICE AND COMPUTER STORAGE MEDIUM OF COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 18/865,875

(22) PCT Filed: May 17, 2022
(86) PCT No.: PCT/CN2022/093383

§ 371 Date: Nov. 14, 2024

(51) Int. Cl. H04W 52/46; H04L 5/00

(52) U.S. Cl. CPC H04W 52/46; H04L 5/0048

(57) ABSTRACT

Embodiments of the present disclosure relate to methods, devices and computer readable media for communication. A repeater forwards with a first power level, to a network device, a first RS received from a terminal device. And the repeater forwards with a second power level, a second RS received from the terminal device. And the repeater receives, from the network device, configuration regarding power control for the repeater. In this way, the transmitting power of repeater and terminal device can be determined according to the quality of two links respectively.

### TECHNICAL FIELD

Embodiments of the present disclosure generally relate to the field of telecommunication, and in particular, to methods, devices and computer storage media of communication based on network-controlled repeater.

### BACKGROUND

Coverage is a fundamental aspect of cellular network deployments. Mobile operators rely on different types of network nodes to offer blanket coverage in their deployments. As a result, new types of network nodes have been considered to increase mobile operators' flexibility for their network deployments.

A network-controlled repeater is an enhancement over conventional radio frequency (RF) repeaters with the capability to receive and process side control information from the network. Side control information could allow a network-controlled repeater to perform its amplify-and-forward operation in a more efficient manner. Potential benefits could include mitigation of unnecessary noise amplification, transmissions and receptions with better spatial directivity, and simplified network integration.

### SUMMARY

In general, embodiments of the present disclosure provide methods, devices and computer storage media of communication based on network-controlled repeater.

In a first aspect, there is provided a method of communication. The method comprises: forwarding, by a repeater with a first power level, to a network device, a first reference signal (RS) received from a terminal device; forwarding, by the repeater with a second power level, to the network device, a second RS received from the terminal device; and receiving, from the network device, configuration regarding power control for the repeater.

In a second aspect, there is provided a method of communication. The method comprises: transmitting, to a repeater, first information regarding two power levels for forwarding reference signal (RS) of a terminal device, from a network device; receiving, a first RS of the terminal device and a second RS with the two power levels respectively, forwarded by the repeater; determining, based on the first RS and the second RS, configuration regarding the power control for the repeater and terminal device respectively; transmitting, to the repeater, the configuration regarding the power control for the repeater; and transmitting, to the terminal device via the repeater, the configuration regarding the power control for the terminal device.

In a third aspect, there is provided a method of communication. The method comprises: receiving, at a terminal device, second information regarding two power levels for transmitting RS of the terminal device, forwarded by a repeater; transmitting, to the network device via the repeater, a first RS and a second RS with the two power levels respectively; and receiving from the network device via the repeater, configuration regarding the power control for the terminal device.

In a fourth aspect, there is provided a method of communication. The method comprises: receiving, at a repeater, third information regarding a reference signal (RS) of a terminal device to be transmitted to a network device, from the network device; receiving, in accordance with the third information, the RS of the terminal device via a first link between the terminal device and the repeater; forwarding, the RS to the network device via a second link between the repeater and the network device; determining, based on the RS, fourth information regarding a quality of the first link; and transmitting, to the network device, the fourth information regarding the quality of the first link; receiving, from the network device, configuration regarding power control for the repeater.

In a fifth aspect, there is provided a method of communication. The method comprises: transmitting, to a repeater, third information regarding a reference signal (RS) of a terminal device, from a network device; receiving, the RS of the terminal device forwarded by the repeater, and fourth information regarding quality of a first link between the repeater and the terminal device, from the repeater; and determining, based on the RS and the fourth information, configuration regarding power control for the repeater and the terminal device respectively; transmitting, to the repeater, configuration regarding the power control for the repeater; transmitting, to the terminal device via the repeater, configuration regarding the power control for the terminal device.

In a sixth aspect, there is provided a method of communication. The method comprises: receiving, at a repeater, sixth information regarding a first reference signal (RS) of the repeater, from a network device; forwarding, to the terminal device, seventh information regarding a second RS of a terminal device; transmitting, to the network device, the first RS based on the sixth information; forwarding, to the network device, the second RS, from the terminal device; and receiving, from the network device, configuration regarding power control for the repeater.

In a seventh aspect, there is provided a method of communication. The method comprises: transmitting, to a repeater, sixth information regarding a first reference signal (RS) of the repeater and seventh information regarding a second RS of a terminal device, from a network device; receiving, the first RS transmitted by repeater, and receiving the second RS forwarded by the repeater; determining, based on the first RS and the second RS, configuration regarding the power control for the repeater and terminal device respectively; transmitting, to the repeater, the configuration regarding the power control for the repeater; and transmitting, to the terminal device via the repeater, the configuration regarding the power control for the terminal device.

In an eighth aspect, there is provided a repeater. The repeater comprises a processor configured to cause the repeater to perform the method according to the first or fourth or sixth aspect of the present disclosure.

In a ninth aspect, there is provided a network device. The network device comprises a processor configured to cause the network device to perform the method according to the second or fifth or seventh aspect of the present disclosure.

In a tenth aspect, there is provided a terminal device. The terminal device comprises a processor configured to cause the terminal device to perform the method according to the third aspect of the present disclosure.

In an eleventh aspect, there is provided a computer readable medium having instructions stored thereon. The instructions, when executed on at least one processor, cause the at least one processor to perform the method according to the first or fourth or sixth aspect of the present disclosure.

In a twelfth aspect, there is provided a computer readable medium having instructions stored thereon. The instructions, when executed on at least one processor, cause the at least one processor to perform the method according to the second or fifth or seventh aspect of the present disclosure.

In a thirteenth aspect, there is provided a computer readable medium having instructions stored thereon. The instructions, when executed on at least one processor, cause the at least one processor to perform the method according to the third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of power control according to embodiments of the present disclosure;

FIG. 3 illustrates a schematic diagram illustrating another process of power control according to embodiments of the present disclosure;

FIG. 4 illustrates a schematic diagram illustrating still another process of power control according to embodiments of the present disclosure;

FIG. 5 illustrates an example method of communication implemented at a network-controlled repeater in accordance with some embodiments of the present disclosure;

FIG. 6 illustrates an example method of communication implemented at a network device in accordance with some embodiments of the present disclosure;

FIG. 7 illustrates an example method of communication implemented at a terminal device in accordance with some embodiments of the present disclosure;

FIG. 8 illustrates an example method of communication implemented at a network-controlled repeater in accordance with some embodiments of the present disclosure;

FIG. 9 illustrates an example method of communication implemented at a network device in accordance with some embodiments of the present disclosure;

FIG. 10 illustrates an example method of communication implemented at a network-controlled repeater in accordance with some embodiments of the present disclosure;

FIG. 11 illustrates an example method of communication implemented at a network device in accordance with some embodiments of the present disclosure;

FIG. 12 is a simplified block diagram of a device that is suitable for implementing embodiments of the present disclosure; and

FIG. 13 is a simplified diagram of time gap between network-controlled repeater and terminal device in accordance with some embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (TAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The term “network-controlled repeater” or “repeater” refers to a radio frequency (RF) repeaters with the capability to amplify-and-forward the received signal. The network-controlled repeater also has the capability to receive and process side control information from the network. Side control information could allow the network-controlled repeater to perform its amplify-and-forward operation in a more efficient manner. Potential benefits could include mitigation of unnecessary noise amplification, transmissions and receptions with better spatial directivity, and simplified network integration.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In one embodiment, the whole link between the network device and the terminal device includes two links when the network-controlled repeater forwards the signal for the network device and the terminal device. One link is between the network device and the network-controlled repeater, and the other link is between the network-controlled repeater and the terminal device. The gain of network-controlled repeater may influence quality (such as, signal to noise ratio (SNR)) of the whole link. And the network device may just determine the SNR of the whole link based on the normal RS from the terminal device via the network controlled repeater. Then the network device may not be able to perform the power control for the network controlled repeater and the terminal device respectively. But the quality of each of the two links may influence the quality of the whole link. So the respective power control for the terminal device and the network controlled repeater is necessary.

Embodiments of the present disclosure provide solutions of estimating the quality of the two links, and determine the transmit power of network-controlled repeater and terminal device according to the quality of two links respectively.

In one aspect, embodiments of the present disclosure provide solutions for estimating the quality by the network-controlled repeater based on the uplink reference signal (RS) configuration for terminal device. In another aspect, embodiments of the present disclosure provide solutions for estimating noise power of two links based on RS transmission with two power levels. In still another aspect, embodiments of the present disclosure provide solutions for estimating quality of the link between the network device and the network-controlled repeater based on dedicated RS configured to the network-controlled repeater by the network device.

Principles and implementations of the present disclosure will be described in detail below with reference to the figures.

### Example of Communication Network

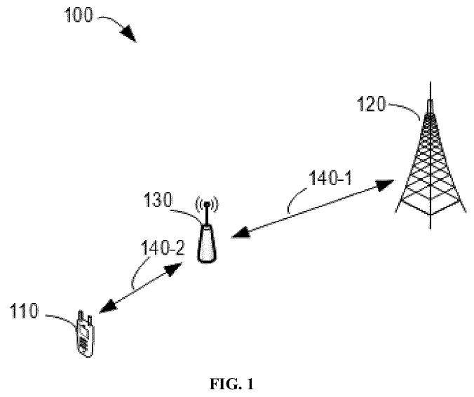

FIG. 1 illustrates a schematic diagram of an example communication network 100 in which some embodiments of the present disclosure can be implemented. As shown in FIG. 1, the communication network 100 may include a terminal device 110, a network device 120 and a network-controlled repeater 130.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the terminal device 110 may communicate with the network device 120 via the network controlled repeater 130. So there are two links in the communication. The link 140-1 is between the network device and the network-controlled 1o repeater. The link 140-2 is between the network-controlled repeater and the terminal device.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 to the network device 120 is referred to as uplink (UL) communication, while communication in a reverse direction from the network device 120 to the terminal device 110 is referred to as downlink (DL) communication.

The gain of the network controlled repeater and the quality of each of the link 140-1 and 140-2 may influence the quality of the whole link. As an example, SNR_{UL} denotes the total uplink SNR between the network device 120 and the terminal device 110. The SNR_{UL} may be determined or estimated by the network device 120 based on the normal RS from the terminal device 110 via the network controlled repeater 130. G_{UL} denotes the gain of UL transmission of the network-controlled repeater 130, P_{s,UL} denotes the uplink transmitting power of the terminal device 110. And δ₁₄₀₋₁² denotes the noise power of the link 140-1, δ₁₄₀₋₂² denotes the noise power of the link 140-2, and for the two links, interference is modeled as noise. So the total uplink SNR between the network device 120 and the terminal device 110 can be represented as following:

$${SNR}_{UL} = \frac{{\vert {G}_{UL} \vert}^{2} {P}_{s , UL}}{{\vert {G}_{UL} \vert}^{2} {δ}_{140 - 2}^{2} + {δ}_{140 - 1}^{2}}$$

Example Implementation of Estimating Quality of Two Links Based on RS Transmission with Two Power Levels.

In this aspect, embodiments of the present disclosure provide solutions for estimating the quality of two links based on UL RS transmission with two power levels. Firstly, the network device may configure two power levels for network-controlled repeater and/or the terminal device. And two UL RS may be configured. Each UL RS may be forwarded with one power level by the network controlled repeater and/or transmitted with one power level by the terminal device. Then the network device may receive two UL RS with two different power levels. Based on the two received RS, the network device may estimate the quality of the two links, and determine the transmit power of network-controlled repeater and terminal device according to the quality of two links respectively.

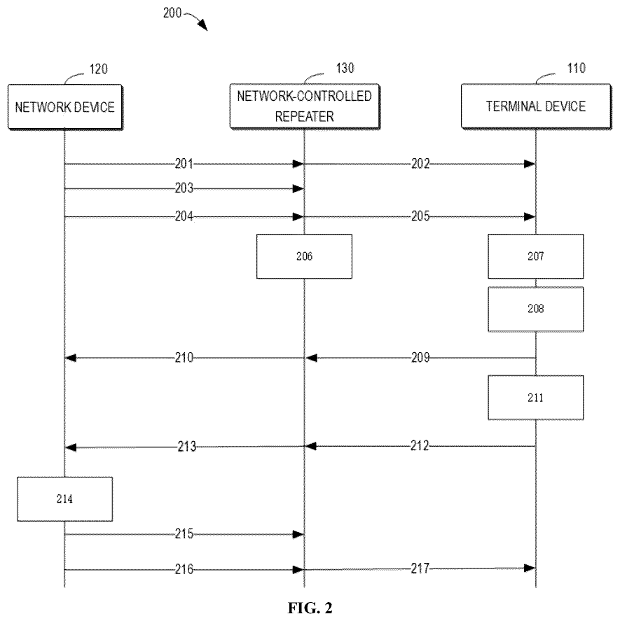

FIG. 2 illustrates a schematic diagram illustrating a process 200 of power control according to embodiments of the present disclosure. For the purpose of discussion, For the purpose of discussion, the process 200 will be described with reference to FIG. 1. The process 200 may involve the terminal device 110, the network device 120 and the network-controlled repeater 130 as illustrated in FIG. 1.

As shown in FIG. 2, the network device 120 may transmit 201, to a network-controlled repeater (e.g., the network-controlled repeater 130), a UL RS configuration message indicating the RS configuration for a terminal device (e.g., the terminal device 110).

In some embodiments, the RS configuration message may be a configuration for SRS or for DMRS. It is to be understood that this is merely an example, and any other suitable messages are also feasible.

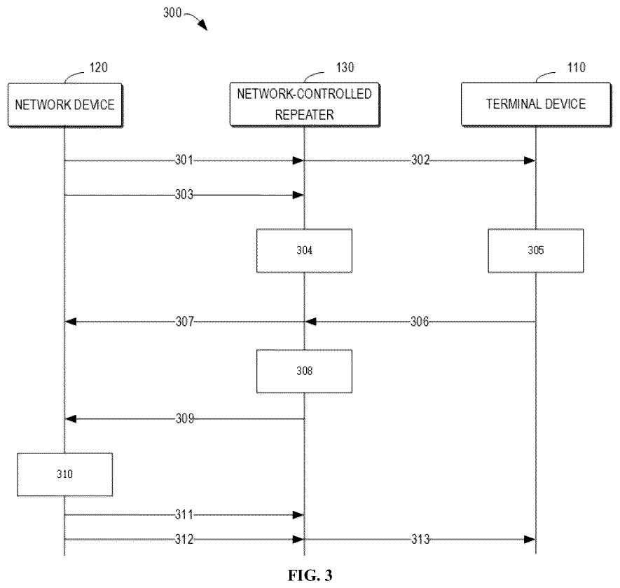

Continue to refer to FIG. 3, upon reception of the RS configuration message, the network-controlled repeater 130 may transmit or forward 202, to a terminal device (e.g., the terminal device 110), the RS configuration.

Still with reference to FIG. 3, the network device 120 may transmit 203, to the network-controlled repeater 130, information regarding two power levels of UL RS (for convenience, also referred to as first information herein) indicating the power level when the network-controlled 130 repeater forwarding the UL RS of terminal device 110 to the network device 120, or when the network-controlled 130 repeater forwarding the UL RS transmitted from terminal device 110 to the network device 120.

Still with reference to FIG. 3, the network device 120 may transmit 204, to the network-controlled repeater 130, information regarding two power levels of UL RS (for convenience, also referred to as second information herein) indicating the power level when the terminal device 110 transmits the UL RS to the network-controlled repeater 130. Upon reception of the second information for two power levels for the UL RS of terminal device 110, the network-controlled repeater 130 may forward 205, to the terminal device 110, the indication for two power levels.

In some embodiments, the second information may comprise information of SRS resource sets and two or more power level associated with the two or more of SRS resource respectively. For example, there are two SRS resource sets, such as, the first resource set and the second resource set. The first resource set has power level P₀. And the second resource set has the power level P₁. One resource in first resource set may be determined, and another resource in the second resource set may be determined. In some embodiments, the two resources have same spatial relation. Then the determined resource in first resource set with the power level P₀ may be for one UL RS. And the determined resource in the second resource set with the power level P₁ may be for another UL RS.

In some embodiments, the second information may comprise information of SRS resource sets and two or more power levels associated with the two or more of SRS resource respectively. For example, there are two SRS resources in a same SRS resource set, such as, the first resource and the second resource. The first resource has power level P₀. And the second resource set has the power level P₁. The first resource in first resource set and the power level P₀ may be for one UL RS. And the second resource and the power level P₁ may be for another UL RS. In some embodiments, P₀ and P₁ may be two values of power. In some embodiments, P₀ may be a value of power indicated for the SRS resource set and P₁ may be indicated by an additional power for the resource set, or P₁ may be indicated by an offset associated with P₀ for the SRS resource set. In some embodiments, P₁ may be applied to the last resource of a SRS resource set. And P₀ may be applied to other SRS resources in a SRS resource set. In some embodiments, the P₁ may be indicated by an additional power for the dedicated SRS resource, or P₁ may be indicated by an additional power offset related to P₀ for the dedicated SRS resource. In some embodiments, the two resources have same spatial relation.

In some embodiments, the second information may comprise information of a SRS resource and two power levels associated with different symbols in the SRS resource respectively. For example, there is a SRS resource with symbol length N. The last N/2 symbols in the SRS resource have power level P₀. And the left symbols in the SRS resource set have the power level P₁. Then the last N/2 symbols in the SRS resource with the power level P₀ may be for one UL RS. And the left symbols in the SRS resource set with the power level P₁ may be for another UL RS. In some embodiments, P₀ and P₁ may be indicated by two values of power. In some embodiments, P₀ may be indicated by a value of power and P₁ may be indicated by an offset associated with P₀.

In some embodiments, the second information may comprise information of two different DMRS resource and two power levels associated with the two DMRS resource respectively. For example, one DMRS resource is related to one DMRS symbol. For example, there are two DMRS resources, the first resource is normal resource for channel estimation indicated by usage field of DMRS in high layer parameter, and the second resource is dedicated resource for noise estimation indicated by usage field of DMRS in high layer parameter. And the normal resource has the power level P₀. The dedicated resource has the power level P₁. Then the normal resource with the power level P₀ may be for one DMRS or one DMRS symbol. And the dedicated resource with the power level P₁ may be for another DMRS or another DMRS symbol.

In some embodiments, P₀ may be indicated by a value of power for the normal resource. And P₁ may be indicated by a power offset associated with P₀ for the dedicated resource. If the transmitting power of normal resource is less than a maximum transmitting power of the related RS, a positive offset is chosen for dedicated resource, for larger power. If the transmitting power of normal resource is equal to the maximum transmitting power of the related RS, a negative offset is chosen for dedicated resource, for smaller power.

In some embodiments, P₀ and P₁ may associated for applying different method for multiplexing with data to the two DMRS resources. For example, P₀ may associates with the method of multiplexing with muted resource for the DMRS resource. And P₁ may associates with the method of multiplexing with data resource for the DMRS resource. In some embodiments, P0 and P1 can be implicitly indicated via the indicated multiplexing method of two DMRS symbols. In some embodiments, a signaling may be used to indicate whether two DMRS symbols apply the same or different multiplexing method with data. In some embodiments, the signaling is a filed in DCI.

In some embodiments, the usage of DMRS may be determined by DCI or RRC. For example, a new field for the usage of DMRS may be defined in RRC. The new field of RRC may indicate the DMRS usage of channel estimation or the DMRS usage of noise estimation. Alternatively, or additionally, a new field for the usage of DMRS may be defined in DCI. The new field of DCI may indicate the DMRS usage of channel estimation or the DMRS usage of noise estimation. In some embodiments, the indication of DMRS usage in DCI may take place of the indication in RRC.

Still with reference to FIG. 2, the network-controlled repeater 130 may decode 206 the first information to get the two power levels for forwarding signal.

Still with reference to FIG. 2, the terminal device 110 may decode 207 the second information to get the two power levels for transmitting signal. And then the terminal device 110 may generate 208 a first RS according to the RS configuration and a first power level in the two power levels for transmitting signal. And then the terminal device 110 may transmit 209, to the network-controlled repeater 130, the generated RS. Upon reception of the RS from the terminal device 110, the network-controlled repeater 130 may forward 210 the received RS to the network device 120 with the first power level in the two power levels for forwarding signal.

Still with reference to FIG. 2, the terminal device 110 may generate 211 a second RS according to the RS configuration and a second power level in the two power levels for transmitting signal. And then the terminal device 110 may transmit 212, to the network-controlled repeater 130, the generated second RS via the RS resource. Upon reception of the RS from the terminal device 110, the network-controlled repeater 130 may forward 213 the received RS to the network device 120 with the first power level in the two power levels for forwarding signal.

In some embodiments, to make sure the channel variance during the two times of RS transmitting is negligible, the time gap between the two transmissions is shorter than a configured value or a predefined value.

Still with reference to FIG. 2, upon reception of the two RS from the network-controlled repeater 130, the network device 120 may determine 214 the noise power of the link 140-1 and the link 140-2 respectively.

As an example, SNR_{UL,P0} denotes the total uplink SNR between the network device 120 and the terminal device 110 with forwarding power level P₀. The SNR_{UL,P0} may be determined by the network device 120 based on the received first UL RS from the terminal device 110. SNR_{UL,P1} denotes the total uplink SNR between the network device 120 and the terminal device 110 with forwarding power level P₁. The SNR_{UL,P1} may be determined by the network device 120 based on the received second UL RS from the terminal device 110. G_{UL,P0} denotes the gain of the network-controlled repeater 130 with forwarding power level P₀, and G_{UL,P1} denotes the gain of the network-controlled repeater 130 with forwarding power level P₁.

P_{s,UL} denotes the uplink transmitting power of the terminal device 110.

$${δ}_{140 - 2}^{2}$$

denotes the noise power of the link 140-2. And

$${δ}_{140 - 1}^{2}$$

denotes the noise power of the link 140-1. So the

$${δ}_{140 - 1}^{2} and {δ}_{140 - 2}^{2}$$

can be determined according to:

$${SNR}_{UL , PO} = \frac{{\vert {G}_{UL , P 0} \vert}^{2} {P}_{s , UL}}{{\vert {G}_{UL , P 0} \vert}^{2} {δ}_{140 - 2}^{2} + {δ}_{b 140 - 1}^{2}}$$

$${SNR}_{UL , P 1} = \frac{{\vert {G}_{UL , P 1} \vert}^{2} {P}_{s , UL}}{{\vert {G}_{UL , P 1} \vert}^{2} {δ}_{140 - 2}^{2} + {δ}_{b 140 - 1}^{2}}$$

Then the network device 120 may determine the transmitting power of the network-controlled repeater 130 and the terminal device 110 based on the

$${δ}_{140 - 1}^{2} and {δ}_{140 - 2}^{2}$$

respectively.

As another example, SNR_{UL,P0} denotes the total uplink SNR between the network device 120 and the terminal device 110 with transmitting power level P₀. The SNR_{UL,P0} may be determined by the network device 120 based on the received first UL RS from the terminal device 110. SNR_{UL,P1} denotes the total uplink SNR between the network device 120 and the terminal device 110 with transmitting power level P₁. The SNR_{UL,P1} may be determined by the network device 120 based on the received second UL RS from the terminal device 110. G_{UL} denotes the gain of the network-controlled repeater 130. P_{s,UL,P0} denotes the uplink transmitting power of the terminal device 110 with transmitting power level P₀, and P_{s,UL,P1} denotes the uplink transmitting power of the terminal device 110 with transmitting power level P₁.

$${δ}_{140 - 2}^{2}$$

denotes the noise power of the link 140-2. And

$${δ}_{140 - 1}^{2}$$

denotes the noise power of the link 140-1. So the

$${δ}_{140 - 1}^{2} and {δ}_{140 - 2}^{2}$$

can be determined according to:

$${SNR}_{UL , PO} = \frac{{\vert {G}_{UL} \vert}^{2} {P}_{s , UL , P 0}}{{\vert {G}_{UL} \vert}^{2} {δ}_{140 - 2}^{2} + {δ}_{b 140 - 1}^{2}}$$

$${SNR}_{UL , P 1} = \frac{{\vert {G}_{UL} \vert}^{2} {P}_{s , UL , P 1}}{{\vert {G}_{UL} \vert}^{2} {δ}_{140 - 2}^{2} + {δ}_{b 140 - 1}^{2}}$$

Then the network device 120 may determine the transmitting power of the network-controlled repeater 130 and the terminal device 110 based on the

$${δ}_{140 - 1}^{2} and {δ}_{140 - 2}^{2}$$

respectively. Then the network device 120 may determine the configuration regarding the power control base on

$${δ}_{140 - 1}^{2} and {δ}_{140 - 2}^{2}$$

for the terminal device 110 and the network-controlled repeater 130.

As another example, both of forwarding power of repeater and the transmitting power of terminal device have two levels. SNR_{UL,P0} denotes the total uplink SNR between the network device 120 and the terminal device 110 with transmitting power level P₀, and the forwarding power P_{0,r} of the network-controlled repeater 130. The SNR_{UL,P0} may be determined by the network device 120 based on the received first UL RS from the terminal device 110. SNR_{UL,P1} denotes the total uplink SNR between the network device 120 and the terminal device 110 with transmitting power level P_{1,u} and the forwarding power P_{1,r} of the network-controlled repeater 130. The SNR_{UL,P1} may be determined by the network device 120 based on the received second UL RS from the terminal device 110. G_{UL,P0} denotes the gain of the network-controlled repeater 130 with forwarding power level P_{0,r}, and G_{UL,P1} denotes the gain of the network-controlled repeater 130 with forwarding power level P_{1,r}. P_{s,UL,P0} denotes the uplink transmitting power of the terminal device 110 with transmitting power level P_{0,u}, and P_{s,UL,P1} denotes the uplink transmitting power of the terminal device 110 with transmitting power level P_{1,u}.

$${δ}_{140 - 2}^{2}$$

denotes the noise power of the link 140-2. And δ₁₄₀₋₁² denotes the noise power of the link 140-1. So the

$${δ}_{140 - 1}^{2} and {δ}_{140 - 2}^{2}$$

can be determined according to:

$${SNR}_{UL , PO} = \frac{{\vert {G}_{UL , P 0} \vert}^{2} {P}_{s , UL , P 0}}{{\vert {G}_{UL} \vert}^{2} {δ}_{140 - 2}^{2} + {δ}_{b 140 - 1}^{2}}$$

$${SNR}_{UL , P 1} = \frac{{\vert {G}_{UL , P 1} \vert}^{2} {P}_{s , UL , P 1}}{{\vert {G}_{UL} \vert}^{2} {δ}_{140 - 2}^{2} + {δ}_{b 140 - 1}^{2}}$$

Then the network device 120 may determine the transmitting power of the network-controlled repeater 130 and the terminal device 110 based on the

$${δ}_{140 - 1}^{2} and {δ}_{140 - 2}^{2}$$

respectively. Then the network device 120 may determine the configuration regarding the power control base on

$${δ}_{140 - 1}^{2} and {δ}_{140 - 2}^{2}$$

for the terminal device 110 and the network-controlled repeater 130.

In some embodiments, if

$${δ}_{140 - 1}^{2} ≪ {δ}_{140 - 2}^{2}$$

for example,

$${δ}_{140 - 2}^{2} ≪ {δ}_{140 - 1}^{2} ,$$

the network device 120 may give a priority of increasing the transmitting power of the network-controlled repeater 130, to achieve the SNR requirement, then the energy can be saved for terminal device.

In some embodiments, if

$${δ}_{140 - 2}^{2} \sim {δ}_{140 - 1}^{2} or {δ}_{140 - 2}^{2} > {δ}_{140 - 1}^{2} ,$$

the network device 120 may give a priority of increasing the transmitting power of the terminal device 110, to achieve the SNR requirement, then a higher energy efficiency is achieved when both network-controlled repeater and terminal device are taken into consideration. Alternatively or additionally, to maximize the energy efficiency, the power control for the terminal device 110 and the network-controlled repeater 130 may be considered simultaneously. Alternatively or additionally, the Power Headroom Report (PHR) may be considered. For example, if there is no room left for the terminal device 110 to increase the transmitting power, the power of the network-controlled repeater 130 may be increased.

In some embodiments, the PHR may be reported by the network-controlled repeater 130 when the PHR of the terminal device 110 is less than a predefined value or when time run out.

Still with reference to FIG. 2, the network device 120 transmits 215, to the network-controlled repeater 130, the configuration regarding the power control. And the network device 120 transmits 216, to the network-controlled repeater 130, the configuration regarding the power control for the terminal device 110, then the network-controlled repeater 130 forwards 217 the configuration to the terminal device 110.

In this way, the quality of the two links can be estimated. Then the transmitting power of network-controlled repeater 130 and terminal device 110 can be determined according to the estimated quality of two links respectively.

In some embodiments, the time duration between two adjacent dedicated RS resource is much longer than that between two adjacent normal RS resource. For example, in case of the power noise of the link 140-1 is more stable than the link 140-2, the dedicated RS resource may only be configured when the power noise of the link 140-1 has changes, such as, the beam pair of link 140-1 is updated. In some embodiments the dedicated RS resource is aperiodic to track the channel variance, but the normal RS resource may be periodic and have short period to track the channel variance caused by mobility of terminal device. So duration between two adjacent dedicated RS resource is much longer than that between two adjacent normal RS resource.

In some embodiments, the power indication of network-controlled repeater 130 may use the scheme of open loop, just like the power control of Physical Random Access Channel (PRACH). For example, a counter may be indicated by DCI to adjust the power of network-controlled repeater. In some embodiments, the power of network-controlled repeater may be based on a predefined or preconfigured relationship between the power and index. For example, several power levels may be predefined. The Pmax denotes the max power of the network-controlled repeater 130. And b bits may be used in side control information for power indication. The power between 0 and Pmax may be quantized to 2\hat{ }b levels. As an example, for b=1, when the indicator indicates “0”, then zero power is used for repeater, when the indicator indicates “1”, then the maximum power is used for repeater. So it can also denote the ON-OFF information. For b=2, the bits 00 denotes that the power indication is zero power, or turn off the repeater, the bits 01 denotes the power of Pmax/2, the bits 10 denotes the power of Pmax, bits 11 is reserved, and it can be used for other information indicating. As another example, for b=3, the bits 001 denotes the power of Pmax/4, the 010 denotes the power of Pmax/2, the 011 denotes the power of 3Pmax/4, and 100 denotes the power of Pmax, bits 101-111 are reserved, and them can be used for other information indicating.

In some embodiments, the power indication for the network-controlled repeater 130 may include the power indication for noise estimation, and the power indication for normal signal forwarding.

It is to be noted that the power control of the network-controlled repeater 130 can be indicated by the transmitting power of the network-controlled repeater 130 or by the gain of the network-controlled repeater 130. The maximum power can be the maximum transmitting power, or the maximum transmitting gain of network-controlled repeater. And in below embodiments, both of these two types indication may be used.

### Example Implementation of Estimating the Quality of the Link by the Network-Controlled Repeater Based on the RS Configuration for Terminal Device

In this aspect, embodiments of the present disclosure provide solutions for estimating the quality of the link by the network-controlled repeater based on the uplink RS configuration for terminal device. Firstly, the network-controlled repeater may estimate the quality of the link between the network-controlled repeater and the terminal device based on the received signal related to the RS configuration. Then, the network-controlled repeater may report the estimation results to the network device. The network-controlled repeater may also forward the RS from the terminal device to the network device. Based on the report and the received RS, the network device may estimate the quality of the two links, and determine the transmit power of network-controlled repeater and terminal device according to the quality of two links respectively.

FIG. 3 illustrates a schematic diagram illustrating a process 300 of a process of power control according to embodiments of the present disclosure. For the purpose of discussion, the process 300 will be described with reference to FIG. 1. The process 300 may involve the terminal device 110, the network device 120 and the network-controlled repeater 130 as illustrated in FIG. 1.

As shown in FIG. 3, the network device 120 may transmit 301, to a network-controlled repeater (e.g., the network-controlled repeater 130), a UL RS configuration message indicating the RS configuration for a terminal device (e.g., the terminal device 110).

In some embodiments, the UL RS configuration message may be a configuration for sounding reference signal (SRS), or demodulation reference signal (DMRS). It is to be understood that this is merely an example, and any other suitable messages are also feasible.

Continue to refer to FIG. 3, upon reception of the RS configuration message, the network-controlled repeater 130 may forward 302, to the terminal device 110, the UL RS configuration.

Still with reference to FIG. 3, the network device 120 may transmit 303, to the network-controlled repeater 130, the information of the UL RS (for convenience, also referred to as third information herein) indicating the information of the UL RS configured to the terminal device.

In some embodiments, the third information may comprises the message indicating the configuration of the UL RS (for convenience, also referred to as a first message herein), and the message indicating the scheduling information of the UL RS (for convenience, also referred to as a second message herein).

In some embodiments, the first message may comprise resource mapping, comb configuration if the UL RS is SRS, scrambling ID of sequence if the UL RS is DMRS, port index of the RS.

In some embodiments, the second message may comprise time advance (TA) information, slot configuration for receiving the RS, and/or frequency domain configuration (such as, sub-carrier space (SCS), bandwidth part (BWP),) cyclic prefix (CP) information. It is to be understood that this is merely an example, and any other suitable messages are also feasible.

In some embodiments, the first message transmitted to network-controlled repeater 130 is different with that transmitted to the terminal device 110. For example, some configuration information may be repackaged with a different signaling format. And the resource allocated for the transmission of the configuration information may be dedicated resource which is allocated for information interaction between network device 120 and network controlled repeater 130.

In some embodiments, the second message transmitted to network-controlled repeater 130 is different with that transmitted to the terminal device 110. For example, some scheduling information may be repackaged in an information element. And the resource allocated for the transmission of the scheduling information may be dedicated resource which is allocated for information interaction between network device 120 and network controlled repeater 130.

Still with reference to FIG. 3, the network-controlled repeater 130 may decode 304 the third information of the UL RS to obtain the first message and the second message.

Then the network-controlled repeater 130 may determine the resource and the sequence of the UL RS based on the first message and the second message. The UL RS resource is for the terminal device 110 transmitting the RS according to the RS configuration.

Still with reference to FIG. 2, the terminal device 110 may generate 305 the RS according to the RS configuration. And then the terminal device 110 may transmit 306, to the network-controlled repeater 130, the generated RS via the link 140-2 between the terminal device 110 and the network controlled device 130, via the RS resource.

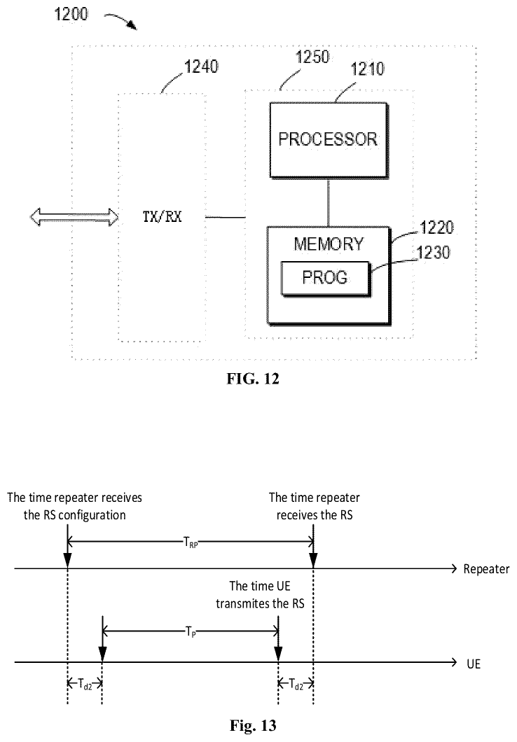

In some embodiments, the transmitting time of the UL RS at the terminal device 110 may consider the decoding time of the network controlled repeater 130 and/or the transmission delay between the network controlled repeater 130 and the terminal device 110. For example, as shown in FIG. 13, T_{RP} denotes decoding time of the network controlled repeater, the start point of T_{RP} is the time that the network-controlled repeater 130 receives the RS configuration. The end point of T_{RP} is equal to or earlier than the time that the network-controlled repeater 130 receives the RS for terminal device 110. T_{d2} denotes the transmission delay between the network-controlled repeater 130 and the terminal device 110. T_{P} denotes a time gap between the terminal device 110 receives UL RS configuration and the time of terminal device 110 transmits the UL RS to the network-controlled device 130. And an assumption is made that the network device 120 sends 301 and 303 simultaneously. So it can be seen in FIG. 12, the following condition may be met:

$${T}_{P} + 2 {T}_{d 2} \geq {T}_{RP}$$

In some embodiments, the network-controlled repeater 130 may report to the network device 120 about the capability of processing the third information, then the network device may determine the time of transmitting the RS by the terminal device 110 according to above condition.

Upon reception of the RS from the terminal device 110, the network-controlled repeater 130 may forward 307 the RS to the network device 120. And the network-controlled repeater 130 may estimate 308 the quality of the link 140-2 between the network-controlled repeater 130 and the terminal device 110 based on the received RS.

In some embodiments, the network-controlled repeater 130 may report to the network device 120 about that it has the capability of processing the baseband signal of RS transmitted by terminal device.

In some embodiments, the network-controlled repeater 130 may generated information regarding the quality of the link 140-2 (for convenience, also referred to as fourth information herein), and the fourth information may comprise at least one of the signal to interference and noise ratio (SINR), or SNR for the link 140-2. It is to be understood that this is merely an example, and any other suitable messages are also feasible.

Still with reference to FIG. 3, the network-controlled repeater 130 may transmit 309, to the network device 120, the fourth information.

Upon reception of the RS and the measurement report from the network-controlled repeater 130, the network device 120 may determine 310 the noise power of the link 140-1 and the link 140-2.

For example, SNR_{UL} denotes the total uplink SNR between the network device 120 and the terminal device 110. The SNR_{UL} may be determined by the network device 120 based on the received UL RS from the terminal device 110. G_{UL} denotes the gain of the network-controlled repeater 130, P_{s,UL} denotes the uplink transmitting power of the terminal device 110.

$${δ}_{140 - 2}^{2}$$

denotes the noise power of the link 140-2 that can be determined based on the received fourth information. And

$${δ}_{140 - 1}^{2}$$

denotes the noise power of the link 140-1. So the

$${δ}_{140 - 1}^{2}$$

can be determined according to:

$${SNR}_{UL} = \frac{{\vert {G}_{UL} \vert}^{2} {P}_{s , UL}}{{\vert {G}_{UL} \vert}^{2} {δ}_{140 - 2}^{2} + {δ}_{b 140 - 1}^{2}}$$

Then the network device 120 may determine the transmitting power of the network-controlled repeater 130 and the terminal device 110 based on the

$${δ}_{140 - 1}^{2} and {δ}_{140 - 2}^{2}$$

respectively. Then the network device 120 may determine the configuration regarding the power control for the terminal device 110 and the network-controlled repeater 130.

In some embodiments, if

$${δ}_{140 - 2}^{2} ≪ {δ}_{140 - 1}^{2} ,$$

for example,

$${δ}_{140 - 2}^{2} ≪ \frac{1}{10} {δ}_{140 - 1}^{2} ,$$

the network device 120 may give a priority of increasing the transmitting power of the network-controlled repeater 130, to achieve the SNR requirement, then the energy can be saved for terminal device.

In some embodiments, if

$${δ}_{140 - 2}^{2} \sim {δ}_{140 - 1}^{2} or {δ}_{140 - 2}^{2} > {δ}_{140 - 1}^{2} ,$$

the network device 120 may give a priority of increasing the transmitting power of the terminal device 110, to achieve the SNR requirement, then a higher energy efficiency is achieved when both network-controlled repeater and terminal device are taken into consideration. Alternatively or additionally, to maximize the energy efficiency, the power control for the terminal device 110 and the network-controlled repeater 130 may be considered simultaneously. Alternatively or additionally, the Power Headroom Report (PHR) may be considered. For example, if there is no room left for the terminal device 110 to increase the transmitting power, the power of the network-controlled repeater 130 may be increased.

In some embodiments, the PHR may be reported by the network-controlled repeater 130 when the PHR of the terminal device 110 is less than a predefined value or when time run out.

Still with reference to FIG. 3, the network device 120 transmits 311, to the network-controlled repeater 130, the configuration regarding the power control for the network-controlled repeater. And the network device 120 transmits 312, to the network-controlled repeater 130, the configuration regarding the power control for the terminal device 110, then the network-controlled repeater 130 forwards 313 the configuration to the terminal device 110.

In this way, the quality of the two links can be estimated. And the transmitting power of network-controlled repeater 130 and terminal device 110 can be determined according to the estimated quality of two links respectively.

In some embodiments, the power indication of network-controlled repeater 130 may use the scheme of open loop, just like the power control of Physical Random Access Channel (PRACH). For example, a counter may be indicated by DCI to adjust the power of network-controlled repeater. In some embodiments, the power of network-controlled repeater may be based on a predefined or preconfigured relationship between the power and index. For example, several power levels may be predefined. The Pmax denotes the max power of the network-controlled repeater 130. And b bits may be used in side control information for power indication. The power between 0 and Pmax may be quantized to 2\hat{ }b levels. As an example, for b=1, when the indicator indicates “0”, then zero power is used for repeater, when the indicator indicates “1”, then the maximum power is used for repeater. So it can also denote the ON-OFF information. For b=2, the bits 00 denotes that the power indication is zero power, or turn off the repeater, the bits 01 denotes the power of Pmax/2, the bits 10 denotes the power of Pmax, bits 11 is reserved, and it can be used for other information indicating. As another example, for b=3, the bits 001 denotes the power of Pmax/4, the 010 denotes the power of Pmax/2, the 011 denotes the power of 3Pmax/4, and 100 denotes the power of Pmax, bits 101-111 are reserved, and them can be used for other information indicating.

In some embodiments, the power indication for the network-controlled repeater 130 may include the power indication for noise estimation, and the power indication for normal signal forwarding.

It is to be noted that the power control of the network-controlled repeater 130 can be indicated by the transmitting power of the network-controlled repeater 130 or by the gain of the network-controlled repeater 130. The maximum power can be the maximum transmitting power, or the maximum transmitting gain of network-controlled repeater. And in below embodiments, both of these two types indication may be used.

Example Implementation of Estimating Quality of the Link Between the Network Device and the Network-Controlled Repeater Based on Dedicated RS Configured to the Network-Controlled Repeater by the Network device

In this aspect, embodiments of the present disclosure provide solutions for estimating quality of the link between the network device and the network-controlled repeater based on dedicated RS configured to the network-controlled repeater by the network device. Firstly, the network device may configure dedicated RS resource and RS to network-controlled repeater. And the network device may also determine RS configuration for terminal device. Then the network-controlled repeater generates and transmits the signal according to dedicated resource and dedicated RS configuration. The terminal device may also transmit RS to network device via network-controlled repeater. Based on the RS from the terminal device and the RS from the network-controlled repeater, the network device may determine the quality of the two links, and then determine the transmit power of network-controlled repeater and terminal device according to the quality of two links respectively.

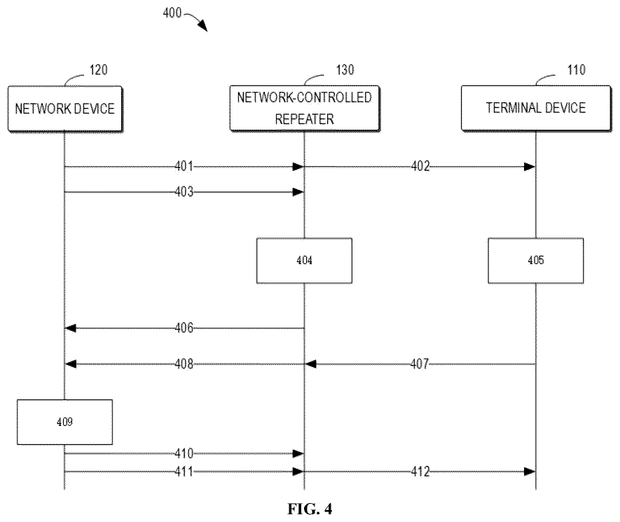

FIG. 4 illustrates a schematic diagram illustrating a process 400 of a process of power control according to embodiments of the present disclosure. For the purpose of discussion, the process 400 will be described with reference to FIG. 1. The process 400 may involve the terminal device 110, the network device 120 and the network-controlled repeater 130 as illustrated in FIG. 1.

As shown in FIG. 4, the network device 120 may transmit 401, to a network-controlled repeater (e.g., the network-controlled repeater 130), information regarding UL RS configuration (for convenience, also referred to as sixth information herein) indicating the RS configuration for a terminal device (e.g., the terminal device 110).

Continue to refer to FIG. 4, upon reception of the fifth information, the network-controlled repeater 130 may forward 402, to the terminal device 110, the RS configuration.

Still with reference to FIG. 4, the network device 120 may transmit 403, to the network-controlled repeater 130, another information regarding UL RS configuration (for convenience, also referred to as seventh information herein) indicating the RS configuration for the network-controlled repeater 130.

In some embodiments, the RS configuration message may be a configuration for SRS or for DMRS. It is to be understood that this is merely an example, and any other suitable messages are also feasible.

Still with reference to FIG. 4, the network-controlled repeater 130 may generate 404 the UL RS according to the seventh information. Then the network-controlled repeater 130 may transmit 406, to the network device 120, the RS generated by the network-controlled repeater 130.

In some embodiments, the period of generating RS by the network controlled repeater is larger than that of forwarding UL RS, or larger than the period of two UL resources. Or the time duration between two adjacent RS generating and transmitting by the network controlled repeater is larger than that of forwarding UL RS, or larger than that of two UL resources.

In some embodiments, the time gap between the RS transmitting and RS from terminal device forwarding by network-controlled repeater is smaller than a predefined value or a preconfigured value.

In some embodiments, the network-controlled repeater 130 may report, the capability for generating RS signal according to configuration, to the network device 120.

Still with reference to FIG. 4, the terminal device 110 may generate 405 the UL RS according to the RS configuration for the terminal device 110. Then the terminal device 110 may transmit 407, to the network-controlled repeater 130, the RS generated by the terminal device 110.

Upon reception of the RS from the terminal device 110, the network-controlled repeater 130 may forward 408 the RS to the network device 120.

Upon reception of the RS generated by the network-controlled repeater 130 and the RS generated by the terminal device 110, the network device 120 may determine 409 the quality of the link 140-1 and the link 140-2.

For example, SNR_{UL} denotes the total uplink SNR between the network device 120 and the terminal device 110. The SNR_{UL} may be determined by the network device 120 based on the UL RS generated by the terminal device 110. G_{UL} denotes the gain of the network-controlled repeater 130, P_{s,UL} denotes the uplink transmitting power of the terminal device 110.

$${δ}_{140 - 2}^{2}$$

denotes the noise power of the link 140-2. And

$${δ}_{140 - 1}^{2}$$

denotes the noise power of the link 140-1 that can be determined based on the UL RS generated by the network controlled repeater 130. So the

$${δ}_{140 - 2}^{2}$$

can be determined according to:

$${SNR}_{UL} = \frac{{\vert {G}_{UL} \vert}^{2} {P}_{s , UL}}{{\vert {G}_{UL} \vert}^{2} {δ}_{140 - 2}^{2} + {δ}_{b 140 - 1}^{2}}$$

Then the network device 120 may determine the transmitting power of the network-controlled repeater 130 and the terminal device 110 based on the

$${δ}_{140 - 1}^{2} and {δ}_{140 - 2}^{2}$$

respectively. Then the network device 120 may determine the configuration regarding the power control for the terminal device 110 and the network-controlled repeater 130.

In some embodiments, if

$${δ}_{140 - 2}^{2} ≪ {δ}_{140 - 1}^{2} ,$$

for example,

$${δ}_{140 - 2}^{2} ≪ \frac{1}{10} {δ}_{140 - 1}^{2} ,$$

the network device 120 may give a priority of increasing the transmitting power of the network-controlled repeater 130, to achieve the SNR requirement, then the energy can be saved for terminal device.

In some embodiments, if

$${δ}_{140 - 2}^{2} \sim {δ}_{140 - 1}^{2} or {δ}_{140 - 2}^{2} > {δ}_{140 - 1}^{2} ,$$

the network device 120 may give a priority of increasing the transmitting power of the terminal device 110, to achieve the SNR requirement, then a higher energy efficiency is achieved when both network-controlled repeater and terminal device are taken into consideration. Alternatively or additionally, to maximize the energy efficiency, the power control for the terminal device 110 and the network-controlled repeater 130 may be considered simultaneously. Alternatively or additionally, the Power Headroom Report (PHR) may be considered. For example, if there is no room left for the terminal device 110 to increase the transmitting power, the power of the network-controlled repeater 130 may be increased.

In some embodiments, the PHR may be reported by the network-controlled repeater 130 when the PHR of the terminal device 110 is less than a predefined value or when time run out.

Still with reference to FIG. 4, the network device 120 transmits 410, to the network-controlled repeater 130, the configuration regarding the power control. And the network device 120 transmits 411, to the network-controlled repeater 130, the configuration regarding the power control for the terminal device 110, then the network-controlled repeater 130 forwards 412 the configuration to the terminal device 110.

In this way, the quality of the two links can be estimated. Then the transmitting power of network-controlled repeater 130 and terminal device 110 can be determined according to the estimated quality of two links respectively.

In some embodiments, the power indication of network-controlled repeater 130 may use the scheme of open loop, just like the power control of Physical Random Access Channel (PRACH). For example, a counter may be indicated by DCI to adjust the power of network-controlled repeater. In some embodiments, the power of network-controlled repeater may be based on a predefined or preconfigured relationship between the power and index. For example, several power levels may be predefined. The Pmax denotes the max power of the network-controlled repeater 130. And b bits may be used in side control information for power indication. The power between 0 and Pmax may be quantized to 2\hat{ }b levels. As an example, for b=1, when the indicator indicates “0”, then zero power is used for repeater, when the indicator indicates “1”, then the maximum power is used for repeater. So it can also denote the ON-OFF information. For b=2, the bits 00 denotes that the power indication is zero power, or turn off the repeater, the bits 01 denotes the power of Pmax/2, the bits 10 denotes the power of Pmax, bits 11 is reserved, and it can be used for other information indicating. As another example, for b=3, the bits 001 denotes the power of Pmax/4, the 010 denotes the power of Pmax/2, the 011 denotes the power of 3Pmax/4, and 100 denotes the power of Pmax, bits 101-111 are reserved, and them can be used for other information indicating.

In some embodiments, the power indication for the network-controlled repeater 130 may include the power indication for noise estimation, and the power indication for normal signal forwarding.

It is to be noted that the power control of the network-controlled repeater 130 can be indicated by the transmitting power of the network-controlled repeater 130 or by the gain of the network-controlled repeater 130. The maximum power can be the maximum transmitting power, or the maximum transmitting gain of network-controlled repeater. And in below embodiments, both of these two types indication may be used.

### Example Implementation of Methods

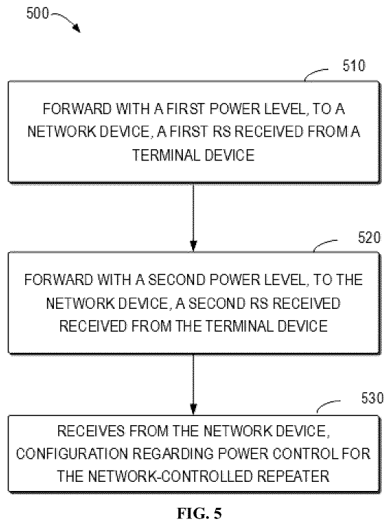

Accordingly, embodiments of the present disclosure provide methods of communication implemented at a terminal device and a network device. These methods will be described below with reference to FIGS. 5 to 11.

FIG. 5 illustrates an example method 500 of communication implemented at a network-controlled repeater in accordance with some embodiments of the present disclosure. For example, the method 500 may be performed at the network-controlled repeater 130 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the network-controlled repeater 130 forwards with a first power level, to a network device 120, a first RS received from a terminal device 110.

At block 520, the network-controlled repeater 130 forwards with a second power level, to the network device 120, a second RS received from the terminal device 110.

At block 530, the network-controlled repeater 130 receives from the network device 120, configuration regarding power control for the network-controlled repeater 130.

In some embodiments, the network-controlled repeater 130 receives first information regarding the first power level and the second power level, from the network device 120.

In some embodiments, the RS comprises at least one of the following: sounding reference signal (SRS), or demodulation reference signal (DMRS).

In some embodiments, the network-controlled repeater 130 forwards, to the terminal device 110, second information regarding two power levels of RS transmitted by the terminal device 110, from the network device 120.

In some embodiments, the second information comprises two power level indications associated with at least one of the following: SRS resource set, SRS resource, or symbol of SRS resource.

In some embodiments, the power level indication comprises at least one of the following: power value, or power offset configured for the resource or the resource set.

In some embodiments, the SRS resources associated with the two power levels have same spatial relation information.

In some embodiments, the second information comprises: two power level indications associated with two DMRS resources or two DMRS symbols.

In some embodiments, the power level indication comprises at least one of the following: an indicated or predefined or configured power offset, or an indicated or predefined or configured method for the DMRS symbol multiplexing with data.

With the method 500, the estimation of the quality of the two links can be determined. Then the transmitting power of network-controlled repeater 130 and terminal device 110 can be determined according to the quality of two links respectively.

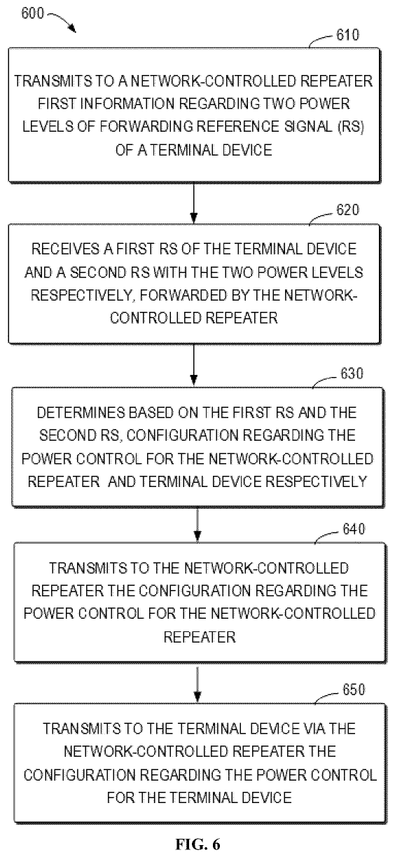

FIG. 6 illustrates an example method 600 of communication implemented at a network device in accordance with some embodiments of the present disclosure. For example, the method 600 may be performed at the network device 120 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the network device 120 transmits to a network-controlled repeater 130, first information regarding two power levels of forwarding reference signal (RS) of a terminal device 1110, from a network device.

At block 620, the network device 120 receives a first RS of the terminal device 110 and a second RS with the two power levels respectively, forwarded by the network-controlled repeater 130.

At block 630, the network device 120 determines based on the first RS and the second RS, configuration regarding the power control for the network-controlled repeater 130 and terminal device 110 respectively.

At block 640, the network device 120 transmits to the network-controlled repeater 130, the configuration regarding the power control for the network-controlled repeater 130.

At block 650, the network device 120 transmits to the terminal device 110 via the network-controlled repeater 130, the configuration regarding the power control for the terminal device 110.

In some embodiments, the network device 120 transmits to the terminal device 110 via the network-controlled repeater 130, second information regarding two power levels of transmitting RS of the terminal device 110.

In some embodiments, the second information comprises two power level indications associated with at least one of the following: SRS resource set, SRS resource, or symbol of SRS resource.

In some embodiments, the power level indication comprises at least one of the following: power value, or power offset configured for the resource or the resource set.

In some embodiments, the SRS resources associated with the two power levels have same spatial relation information.

In some embodiments, the second information comprises: two power level indications associated with two DMRS resources or two DMRS symbols.

In some embodiments, the power level indication comprises at least one of the following: an indicated or predefined or configured power offset, or an indicated or predefined or configured method for the DMRS symbol multiplexing with data.

With the method 500, the estimation of the quality of the two links can be determined. Then the transmitting power of network-controlled repeater 130 and terminal device 110 can be determined according to the quality of two links respectively.

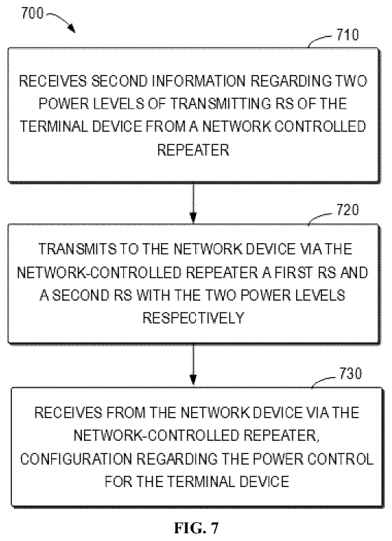

FIG. 7 illustrates an example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the terminal device 110 receives second information regarding two power levels of transmitting RS of the terminal device 110, from a network controlled repeater 130.

At block 720, the terminal device 110 transmits to the network device 120 via the network-controlled repeater 130, a first RS and a second RS with the two power levels respectively.

At block 730, the terminal device 110 receives from the network device 120 via the network-controlled repeater 130, configuration regarding the power control for the terminal device 110.

In some embodiments, the terminal device 110 transmits the second RS before a period of time after transmitting the first RS, and the period of time is predefined preconfigured.

In some embodiments, the RS comprises at least one of the following: sounding reference signal (SRS), or demodulation reference signal (DMRS).

In some embodiments, the terminal device determines usage of the DMRS by downlink control information (DCI) and/or configured Radio Resource Control (RRC) information element.

With the method 700, the estimation of the quality of the two links can be determined. Then the transmitting power of network-controlled repeater 130 and terminal device 110 can be determined according to the quality of two links respectively.

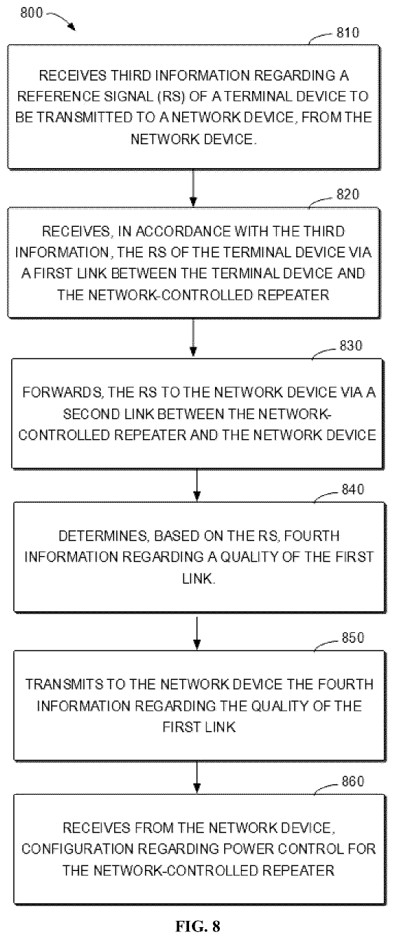

FIG. 8 illustrates an example method 800 of communication implemented at a network-controlled repeater in accordance with some embodiments of the present disclosure. For example, the method 800 may be performed at the network-controlled repeater 130 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the network-controlled repeater 130 receives third information regarding a reference signal (RS) of a terminal device to be transmitted to a network device, from the network device.

At block 820, the network-controlled repeater 130 receives, in accordance with the third information, the RS of the terminal device 110 via a first link between the terminal device 110 and the network-controlled repeater 130.

At block 830, the network-controlled repeater 130 forwards, the RS to the network device 120 via a second link between the network-controlled repeater 130 and the network device 110.

At block 840, the network-controlled repeater 130 determines, based on the RS, fourth information regarding a quality of the first link.

At block 850, the network-controlled repeater 130 transmits to the network device 120, the fourth information regarding the quality of the first link;

At block 860, the network-controlled repeater 130 receives from the network device, configuration regarding power control for the network-controlled repeater 130.

In some embodiments, the third information comprises at least one of the following: configuration information of the RS, or scheduling information of the RS.

In some embodiments, the configuration information of the RS comprises at least one of the following: resource mapping, port index, comb configuration, or scrambling ID.

In some embodiments, the scheduling information of the RS comprises at least one of the following: time advance (TA) information, slot configuration, subcarrier spacing, bandwidth part, or cyclic prefix (CP) information.

In some embodiments, the second information comprises at least one of the following: signal to noise ratio (SNR) of the first link, signal to interference and noise ratio (SINR) of the first link, noise power of the first link, or power of noise and interference of the first link.

In some embodiments, the network-controlled repeater 130 receives the RS after at least a period of time, in accordance with receiving the first information, and the period of time is for processing the first information by the network-controlled repeater 130.

In some embodiments, the RS comprises at least one of the following: sounding reference signal (SRS), or demodulation reference signal (DMRS).

In some embodiments, the network-controlled repeater 130 transmits to the network device 120, fifth information regarding a period of time, and the period of time is a capability of baseband signal processing of the RS.

With the method 800, the estimation of the quality of the two links can be determined. Then the transmitting power of network-controlled repeater 130 and terminal device 110 can be determined according to the quality of two links respectively.

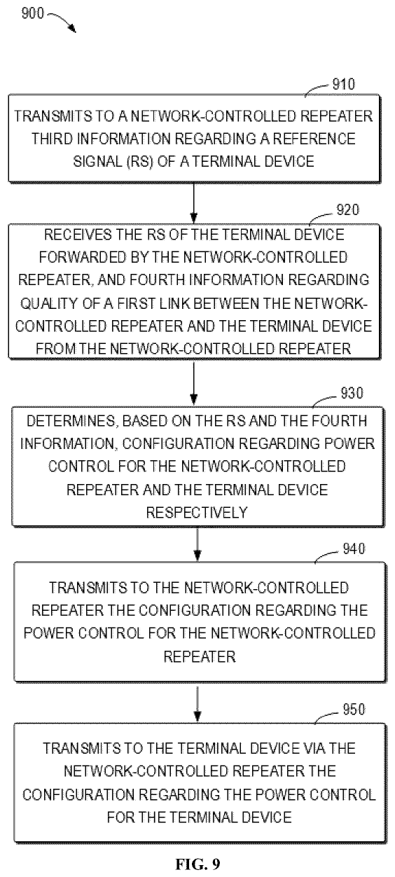

FIG. 9 illustrates an example method 900 of communication implemented at a network device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the network device 120 transmits to a network-controlled repeater 130, third information regarding a reference signal (RS) of a terminal device 110.

At block 920, the network device 120 receives the RS of the terminal device 110 forwarded by the network-controlled repeater 130, and fourth information regarding quality of a first link between the network-controlled repeater 130 and the terminal device 110, from the network-controlled repeater 130.

At block 930, the network device 120 determines, based on the RS and the fourth information, configuration regarding power control for the network-controlled repeater 130 and the terminal device 110 respectively.

At block 940, the network device 120 transmits to the network-controlled repeater 130, configuration regarding the power control for the network-controlled repeater 130.

At block 950, the network device 120 transmits to the terminal device 110 via the network-controlled repeater 130, configuration regarding the power control for the terminal device 110.

With the method 900, the estimation of the quality of the two links can be determined. Then the transmitting power of network-controlled repeater 130 and terminal device 110 can be determined according to the quality of two links respectively.

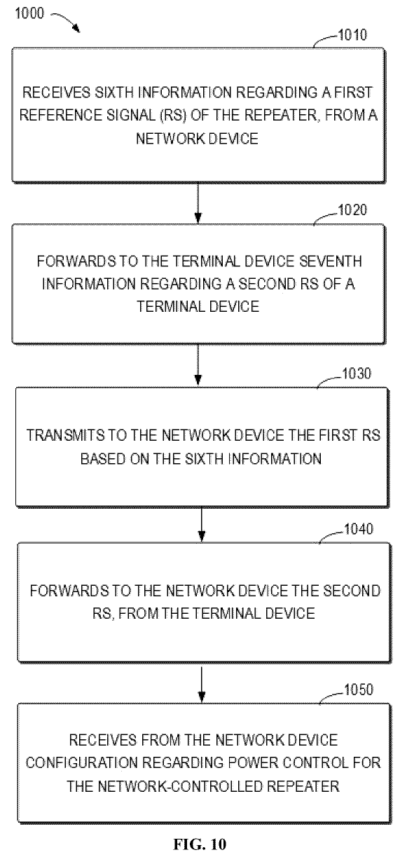

FIG. 10 illustrates an example method 1000 of communication implemented at a network-controlled repeater in accordance with some embodiments of the present disclosure. For example, the method 1000 may be performed at the network-controlled repeater 130 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the network-controlled repeater 130 receives sixth information regarding a first reference signal (RS) of the repeater, from a network device 120.

At block 1020, the network-controlled repeater 130 forwards to the terminal device 110, seventh information regarding a second RS of a terminal device 110.

At block 1030 the network-controlled repeater 130 transmits to the network device 120 the first RS based on the sixth information.

At block 1040, the network-controlled repeater 130 forwards to the network device 120, the second RS, from the terminal device 110.

At block 1050, the network-controlled repeater 130 receives from the network device 120, configuration regarding power control for the network-controlled repeater 130.

In some embodiments, the time gap between transmitting the first RS and forwarding the second RS is less than a predefined or preconfigured threshold.

In some embodiments, the network-controlled repeater 130 transmits to the network device 120, eighth information regarding the capability of RS generating of the network-controlled repeater 130.

With the method 1000, the estimation of the quality of the two links can be determined. Then the transmitting power of network-controlled repeater 130 and terminal device 110 can be determined according to the quality of two links respectively.

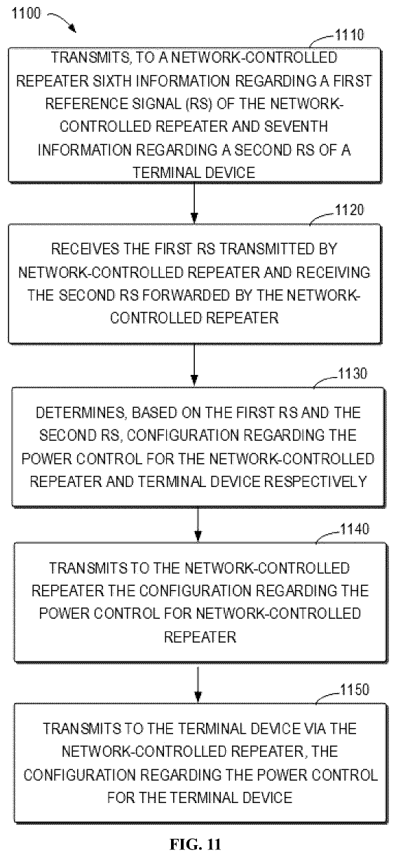

FIG. 11 illustrates an example method 1100 of communication implemented at a network device in accordance with some embodiments of the present disclosure. For example, the method 1000 may be performed at the network device repeater 120 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the network device 120 transmits, to a network-controlled repeater 130, sixth information regarding a first reference signal (RS) of the network-controlled repeater 130 and seventh information regarding a second RS of a terminal device 110.

At block 1120, the network device 120 receives the first RS transmitted by network-controlled repeater 130, and receiving the second RS forwarded by the network-controlled repeater 130.

At block 1130, the network device 120 determines, based on the first RS and the second RS, configuration regarding the power control for the network-controlled repeater 130 and terminal device 110 respectively.

At block 1140, the network device 120 transmits to the network-controlled repeater 130, the configuration regarding the power control for network-controlled repeater 130.

At block 1150, the network device 120 transmits to the terminal device 110 via the network-controlled repeater 130, the configuration regarding the power control for the terminal device 110.

With the method 1100, the estimation of the quality of the two links can be determined. Then the transmitting power of network-controlled repeater 130 and terminal device 110 can be determined according to the quality of two links respectively.

It is to be understood that the operations of methods 500 to 1100 are similar as that described in connection with FIGS. 2 to 4, and thus other details are not repeated here for concise.

### Example Implementation of Devices and Apparatuses

FIG. 12 is a simplified block diagram of a device 1200 that is suitable for implementing embodiments of the present disclosure. The device 1200 can be considered as a further example implementation of the terminal device 110 and the network device 120 and the network-controlled repeater 130 as shown in FIG. 1. Accordingly, the device 1200 can be implemented at or as at least a part of the terminal device 110 and the network device 120 and the network-controlled repeater 130.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 2 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a repeater comprises a circuitry configured to: receive first information regarding two power levels of forwarding reference signal (RS) of a terminal device, from a network device; forward, to the network device, a first RS transmitted by the terminal device and a second RS transmitted by the terminal device with the two power levels respectively; and receive, from the network device, configuration regarding power control for the repeater.

In some embodiments, a network device comprises a circuitry configured to: transmit, to a repeater, first information regarding two power levels of forwarding reference signal (RS) of a terminal device, from a network device; receive, a first RS of the terminal device and a second RS with the two power levels respectively, forwarded by the repeater; determine, based on the first RS and the second RS, configuration regarding the power control for the repeater and terminal device respectively; transmit, to the repeater, the configuration regarding the power control for the repeater; and transmit, to the terminal device via the repeater, the configuration regarding the power control for the terminal device.

In some embodiments, a terminal device comprises a circuitry configured to: receive second information regarding two power levels of transmitting RS of the terminal device, from a repeater; transmit to the network device via the repeater, a first RS and a second RS with the two power levels respectively; and receive from the network device via the repeater, configuration regarding the power control for the terminal device.

In some embodiments, a repeater comprises a circuitry configured to: receive third information regarding a reference signal (RS) of a terminal device to be transmitted to a network device, from the network device; receive, in accordance with the third information, the RS of the terminal device via a first link between the terminal device and the repeater; forward, the RS to the network device via a second link between the repeater and the network device; determine, based on the RS, fourth information regarding a quality of the first link; and transmit, to the network device, the fourth information regarding the quality of the first link; receive, from the network device, configuration regarding power control for the repeater.

In some embodiments, a network device comprises a circuitry configured to: transmit, to a repeater, third information regarding a reference signal (RS) of a terminal device; receive the RS of the terminal device forwarded by the repeater, and fourth information regarding quality of a first link between the repeater and the terminal device, from the repeater; determine based on the RS and the fourth information, configuration regarding power control for the repeater and the terminal device respectively; transmit to the repeater, configuration regarding the power control for the repeater; and transmit to the terminal device via the repeater, configuration regarding the power control for the terminal device.

In some embodiments, a repeater comprises a circuitry configured to: receive sixth information regarding a first reference signal (RS) of the repeater, from a network device; forward to the terminal device, seventh information regarding a second RS of a terminal device; transmit to the network device, the first RS based on the sixth information; forward to the network device, the second RS, from the terminal device; and receive from the network device, configuration regarding power control for the repeater.

In some embodiments, a network device comprises a circuitry configured to: transmit, to a repeater, sixth information regarding a first reference signal (RS) of the repeater and seventh information regarding a second RS of a terminal device; receive, the first RS transmitted by repeater, and receiving the second RS forwarded by the repeater; determine, based on the first RS and the second RS, configuration regarding the power control for the repeater and terminal device respectively; transmit, to the repeater, the configuration regarding the power control for the repeater; and transmit, to the terminal device via the repeater, the configuration regarding the power control for the terminal device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

A method of communication, comprising: forwarding, by a repeater with a first power level, to a network device, a first RS received from a terminal device; forwarding, by the repeater with a second power level, a second RS received from the terminal device; and receiving, from the network device, configuration regarding power control for the repeater.

The method as above, further comprising: receiving, first information regarding the first power level and the second power level, from the network device.

The method as above, wherein the RS comprises at least one of the following: sounding reference signal (SRS), or demodulation reference signal (DMRS).

The method as above, further comprising: forwarding, to the terminal device, second information regarding two power levels of RS transmitted by the terminal device, from the network device.

The method as above, wherein the second information comprises two power level indications associated with at least one of the following: SRS resource set, SRS resource, or symbol of SRS resource.

The method as above, wherein the power level indication comprises at least one of the following: power value, or power offset configured for the resource or the resource set.

The method as above, wherein the SRS resources associated with the two power levels have same spatial relation information.

The method as above, wherein the second information comprises: two power level indications associated with two DMRS resources or two DMRS symbols.

The method as above, wherein the power level indication comprises at least one of the following: an indicated or predefined or configured power offset, or an indicated or predefined or configured method for the DMRS symbol multiplexing with data.

A method of communication, comprising: transmitting, to a repeater, first information regarding two power levels of forwarding reference signal (RS) of a terminal device, from a network device; receiving, a first RS of the terminal device and a second RS with the two power levels respectively, forwarded by the repeater; determining, based on the first RS and the second RS, configuration regarding the power control for the repeater and terminal device respectively; transmitting, to the repeater, the configuration regarding the power control for the repeater; and transmitting, to the terminal device via the repeater, the configuration regarding the power control for the terminal device.

The method as above, further comprising: transmitting, to the terminal device via the repeater, second information regarding two power levels of transmitting RS of the terminal device.

The method as above, wherein the second information comprises two power level indications associated with at least one of the following: SRS resource set, SRS resource, or symbol of SRS resource.

The method as above, wherein the power level indication comprises at least one of the following: power value, or power offset configured for the resource or the resource set.

The method as above, wherein the SRS resources associated with the two power levels have same spatial relation information.

The method as above, wherein the second information comprises: two power level indications associated with two DMRS resources or two DMRS symbols.

The method as above, wherein the power level indication comprises at least one of the following: an indicated or predefined or configured power offset, or an indicated or predefined or configured method for the DMRS symbol multiplexing with data.

A method of communication, comprising: receiving, at a terminal device, second information regarding two power levels of transmitting RS of the terminal device, from a repeater; transmitting, to the network device via the repeater, a first RS and a second RS with the two power levels respectively; and receiving from the network device via the repeater, configuration regarding the power control for the terminal device.

The method as above, further comprising: transmitting, the second RS, before a period of time after transmitting the first RS, wherein the period of time is predefined preconfigured.

The method as above, wherein the RS comprises at least one of the following: sounding reference signal (SRS), or demodulation reference signal (DMRS).

The method as above, further comprise: determining, usage of the DMRS by downlink control information (DCI) and/or configured Radio Resource Control (RRC) information element.

A method of communication, comprising: receiving, at a repeater, third information regarding a reference signal (RS) of a terminal device to be transmitted to a network device, from the network device; receiving, in accordance with the third information, the RS of the terminal device via a first link between the terminal device and the repeater; forwarding, the RS to the network device via a second link between the repeater and the network device; determining, based on the RS, fourth information regarding a quality of the first link; transmitting, to the network device, the fourth information regarding the quality of the first link; and receiving, from the network device, configuration regarding power control for the repeater.

The method as above, wherein the third information comprises at least one of the following: configuration information of the RS, or scheduling information of the RS.

The method as above, wherein the configuration information of the RS comprises at least one of the following: resource mapping, port index, comb configuration, or scrambling ID.

The method as above, wherein the scheduling information of the RS comprises at least one of the following: time advance (TA) information, slot configuration, subcarrier spacing, bandwidth part, or cyclic prefix (CP) information.

The method as above, wherein the second information comprises at least one of the following: signal to noise ratio (SNR) of the first link, signal to interference and noise ratio (SINR) of the first link, noise power of the first link, or power of noise and interference of the first link.

The method as above, wherein receiving the RS comprises: receiving the RS after at least a period of time, in accordance with receiving the first information, wherein the period of time is for processing the first information by the repeater.

The method as above, wherein the RS comprises at least one of the following: sounding reference signal (SRS), or demodulation reference signal (DMRS).

The method as above, further comprises: transmitting, to the network device, fifth information regarding a period of time, wherein the period of time is a capability of baseband signal processing of the RS.

A method of communication, comprising: transmitting, to a repeater, third information regarding a reference signal (RS) of a terminal device, from a network device; receiving, the RS of the terminal device forwarded by the repeater, and fourth information regarding quality of a first link between the repeater and the terminal device, from the repeater; determining, based on the RS and the fourth information, configuration regarding power control for the repeater and the terminal device respectively; transmitting, to the repeater, configuration regarding the power control for the repeater; and transmitting, to the terminal device via the repeater, configuration regarding the power control for the terminal device.

A method of communication, comprising: receiving, at a repeater, sixth information regarding a first reference signal (RS) of the repeater, from a network device; forwarding, to the terminal device, seventh information regarding a second RS of a terminal device; transmitting, to the network device, the first RS based on the sixth information; forwarding, to the network device, the second RS, from the terminal device; and receiving, from the network device, configuration regarding power control for the repeater.

The method as above, wherein time gap between transmitting the first RS and forwarding the second RS is less than a predefined or preconfigured threshold.

The method as above further comprises: transmitting, to the network device, eighth information regarding the capability of RS generating of the repeater.

A method of communication, comprising: transmitting, to a repeater, sixth information regarding a first reference signal (RS) of the repeater and seventh information regarding a second RS of a terminal device, from a network device; receiving, the first RS transmitted by repeater, and receiving the second RS forwarded by the repeater; determining, based on the first RS and the second RS, configuration regarding the power control for the repeater and terminal device respectively; transmitting, to the repeater, the configuration regarding the power control for the repeater; and transmitting, to the terminal device via the repeater, the configuration regarding the power control for the terminal device.

A method of communication, comprising: receiving, at a terminal device, information regarding a RS of the terminal device, from a network device via a repeater; transmitting, to the network device via the repeater, the RS; and receiving from the network device via the repeater, configuration regarding the power control for the terminal device.

A repeater, comprising: a processor configured to cause the repeater to perform the above methods.

A network device, comprising: a processor configured to cause the network device to perform the above methods.

A terminal device, comprising: a processor configured to cause the terminal device to perform the above methods.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
forwarding, by a repeater with a first power level, to a network device, a first reference signal (RS) received from a terminal device;
forwarding, by the repeater with a second power level, to the network device, a second RS received from the terminal device; and
receiving, from the network device, configuration regarding power control for the repeater.

2. The method of claim 1, further comprising:
receiving, first information regarding the first power level and the second power level, from the network device.

3. The method of claim 1, wherein the RS comprises at least one of the following:
sounding reference signal (SRS), or
demodulation reference signal (DMRS).

4. The method of claim 1, further comprising:
forwarding, to the terminal device, second information regarding two power levels of RS transmitted by the terminal device, from the network device.

5. The method of claim 4, wherein the second information comprises two power level indications associated with at least one of the following:
SRS resource set,
SRS resource, or
symbol of SRS resource.

6. The method of claim 5, wherein the power level indication comprises at least one of the following:
power value, or
power offset configured for the resource or the resource set.

7. The method of claim 5, wherein the SRS resources associated with the two power levels have same spatial relation information.

8. The method of claim 4, wherein the second information comprises:
two power level indications associated with two DMRS resources or two DMRS symbols.

9. The method of claim 8, wherein the power level indication comprises at least one of the following:
an indicated or predefined or configured power offset, or
an indicated or predefined or configured method for the DMRS symbol multiplexing with data.

10. A method of communication, comprising:
transmitting, to a repeater, first information regarding two power levels of forwarding reference signal (RS) of a terminal device, from a network device;
receiving, a first RS of the terminal device and a second RS with the two power levels respectively, forwarded by the repeater;
determining, based on the first RS and the second RS, configuration regarding the power control for the repeater and terminal device respectively;
transmitting, to the repeater, the configuration regarding the power control for the repeater; and
transmitting, to the terminal device via the repeater, the configuration regarding the power control for the terminal device.

11. The method of claim 10, further comprising:
transmitting, to the terminal device via the repeater, second information regarding two power levels of transmitting RS of the terminal device.

12. The method of claim 11, wherein the second information comprises two power level indications associated with at least one of the following:
SRS resource set,
SRS resource, or
symbol of SRS resource.

13. The method of claim 12, wherein the power level indication comprises at least one of the following:
power value, or
power offset configured for the resource or the resource set.

14. The method of claim 11, wherein the second information comprises:
two power level indications associated with two DMRS resources or two DMRS symbols.

15. The method of claim 14, wherein the power level indication comprises at least one of the following:
an indicated or predefined or configured power offset, or
an indicated or predefined or configured method for the DMRS symbol multiplexing with data.

16. A method of communication, comprising:
receiving, at a terminal device, second information regarding two power levels of transmitting RS of the terminal device, from a repeater;
transmitting, to the network device via the repeater, a first RS and a second RS with the two power levels respectively; and
receiving from the network device via the repeater, configuration regarding the power control for the terminal device.

17. The method of claim 16, further comprising:
transmitting, the second RS, before a period of time after transmitting the first RS, wherein the period of time is predefined preconfigured.

18. The method of claim 16, wherein the RS comprises at least one of the following:
sounding reference signal (SRS), or
demodulation reference signal (DMRS).

19. The method of claim 18, further comprise:
determining, usage of the DMRS by downlink control information (DCI) and/or configured Radio Resource Control (RRC) information element.

20. (canceled)
